(19) United States
(12) Patent Application Publication
(10) Pub. No.: US 2016/0032175 A1
(43) Pub. Date: Feb. 4, 2016

(54) Method For Coating A Well Treatment Chemical

(71) Applicant: Energy & Environmental Services, Inc., Oklahoma City, OK (US)

(72) Inventors: Lewis R. Norman, Duncan, OK (US); Melvin B. Smith, Oklahoma City, OK (US); Todd Jelinek, Edmond, OK (US)

(21) Appl. No.: 14/881,995

(22) Filed: Oct. 13, 2015

Related U.S. Application Data
(63) Continuation-in-part of application No. 14/236,022, filed on Mar. 24, 2014.
(60) Provisional application No. 62/063,054, filed on Oct. 13, 2014.

(51) Int. Cl. C09K 8/70; E21B 43/24; E21B 43/16; E21B 43/26; E21B 43/267

(52) U.S. Cl. CPC C09K 8/70; E21B 43/26; E21B 43/267; E21B 43/16; E21B 43/2405

(57) ABSTRACT

A solid chemical delivery system for delivering chemicals to an underground. formation. The solid chemical is formed by dehydrating a silica to form anhydrous silica. Well chemicals are then introduced to the silica and form a tablet or pelletized chemical. The pelletized chemical is coated to further time-release the introduction of the chemical. The pelletized solid chemical is then delivered to the underground formation through the well bore with a proppant and fracturing fluid. This allows the well treatment chemicals to be released over time.

### CROSS REFERENCE TO RELATED APPLICATION

This application claims the benefit of U.S. Provisional Patent Application Ser. No. 62/063,054, filed Oct. 13, 2014, and is a continuation-in-part of U.S. patent application Ser. No. 14/236,022, filed on Jan. 29, 2014, which is a 371 of PCT Application Serial No. PCT/US2012/032376, filed Apr. 5, 2012, the entire contents of which are incorporated herein by reference.

### FIELD

The present invention relates to hydraulic fracturing and delivery methods for well treatment chemicals.

### SUMMARY

The invention is directed to a method for fracturing a formation accessible through a wellbore. The method comprises the steps of providing an anhydrous, or dried, amorphous silica matrix formed to early a well treatment chemical within the matrix to form a solid chemical and pumping the solid chemical, a proppant, and a fracturing fluid into the wellbore. The solid chemical is positioned within a fracture created by the fracturing fluid and provides a metered release of the well treatment chemical therefrom.

In another embodiment the invention is directed to a well treatment device. The device comprises an anhydrous silica matrix and a well treatment chemical held within the silica matrix to form a solid chemical. The chemical is releasable from the silica matrix within a wellbore.

In another embodiment, the invention is directed to a device for delivering a well treatment chemical into a wellbore. The chemical is prepared by a process. The process comprises providing a silica matrix, heating the silica matrix to drive off moisture contained. therein to form an anhydrous silica, and mixing the anhydrous silica with a well treatment chemical to absorb the well treatment chemical with the silica matrix to form a solid chemical.

### BRIEF DESCRIPTION OF THE DRAWINGS

FIG. 1 is a diagrammatic representation of an injection well and material delivery system for delivery of the well treatment chemical created in the process of FIG. 2.

FIG. 2 is a flow chart demonstrating a process of creating the solid well treatment chemical of the present invention.

FIG. 3 is a diagrammatic representation of a process for coating the present invention.

### DETAILED DESCRIPTION OF THE DRAWINGS

A hydraulic fracture is formed by pumping the fracturing fluid into the wellbore at a rate sufficient to increase pressure downhole to exceed that of the fracture gradient of the rock. The rock cracks and the fracture fluid enter the rock, extending the crack. To keep this fracture open after the injection stops, a solid proppant, commonly sand, is added to the fluid. The propped fracture is permeable enough to allow the flow of formation fluids to the well. Formation fluids include gas, oil, salt water, fresh water and fluids introduced to the formation during completion of the well during fracturing.

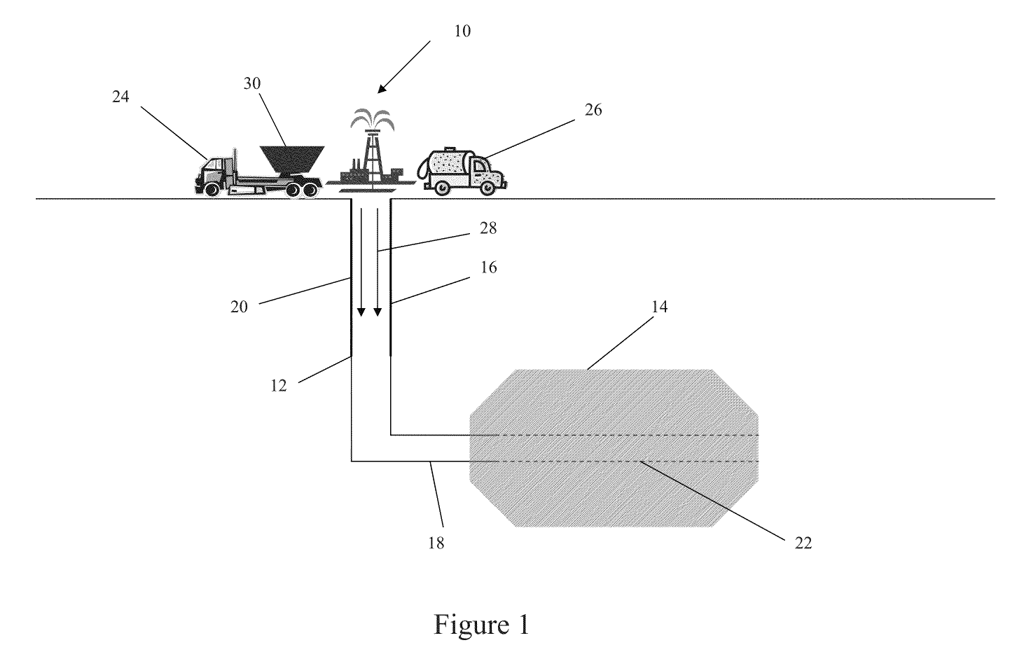

Turning to the figures in general and FIG. 1 specifically, shown therein is an injection well 10 for use with the claimed invention. The injection well comprises a well shaft 12 within a subterranean formation 14. The well shaft 12 comprises a vertical shaft 16 and may comprise a horizontal section 18. Further, the well shaft 12 comprises a well casing 20 that is adapted to seal a portion of the well shaft 12 such that fluids may not travel into or out of the subterranean formation 14 proximate the well casing. The well shaft 12 further comprises a production portion 22 that does not have a well casing 20 such that well treatment chemicals, such as fracturing chemicals, may be delivered to the subterranean formation 14 and desired products such as oil, natural gas, and natural gas liquids are removed from the subterranean formation.

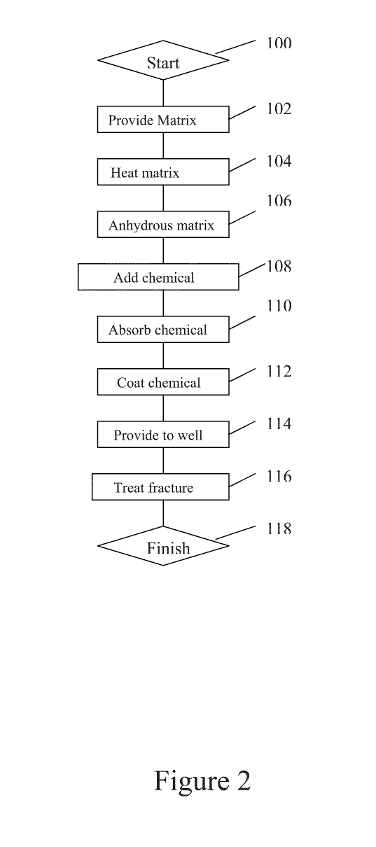

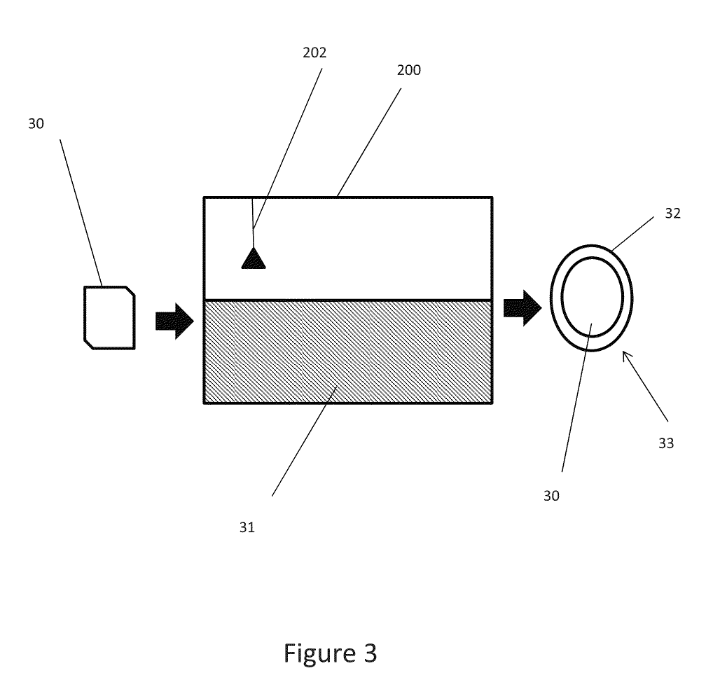

A material delivery system 24 is provided at ground level proximate the injection well 10. The material delivery system 24 delivers products into the well shaft 12 for enhancement of the drilling process. The material delivery system is preferably used in conjunction with a fracturing system 26 for delivery of ground level fracturing fluid 28 into the well shaft 12. The fracturing fluid 28, when delivered to the subterranean formation 14, causes hydraulic fracture and allows delivery of proppant and well treatment chemicals. The material delivery system 24 comprises a well treatment product 30 which is created through the process of FIG. 2. Preferably, the well treatment product 30 is a precipitated, amorphous silica matrix that is heated and mixed with a liquid well treatment product in the method described in FIG. 3 to form a solid chemical. A precipitated silica matrix is preferred over other silica carriers, such as diatomaceous earth or lava rock, as precipitated silica allows for a much greater rate of adsorption of liquid well treatment product per gram.

With reference now to FIG. 2, a method for creating an enhanced well treatment product 30 for delivery to the subterranean formation 22 by the material delivery system 24 (FIG. 1) is shown. As one skilled in the art will appreciate, liquid products have associated weaknesses, such as immediate delivery to a treatment location and an inability to control the delivery of chemical product over time. The method shown in FIG. 3 provides a process for creating a well treatment product 30 in a solid matrix form, The method starts at 100, An amorphous, preferably precipitated silica matrix is provided at 102. The silica matrix is heated at 104 to drive off moisture contained therein, When the moisture is removed, an anhydrous silica is left at 106. The anhydrous silica is mixed with a well treatment chemical and enzyme at 108 and the well treatment chemical is absorbed within the anhydrous silica matrix at 110 to form a solid chemical, The solid chemical may then be coated at 112. The heating of the fracturing fluid 28 may take place before or after the solid chemical is added to the fracturing fluid, The solid chemical, a proppant, and the fracturing fluid 28 are provided to the wellbore at 114. This causes the solid chemical to be positioned within the subterranean formation 14 and more particularly a fracture therein created by the fracturing fluid, providing a metered release of well treatment chemical at 116. The method ends at 118.

The solid chemical may comprise a silica spheroid, a silica pellet, or other shape. Preferably, the solid chemical silica matrix is a porous anhydrous silica spheroid. As used herein, “well treatment product” 30 comprises an advantageous chemical such as a scale inhibitor, corrosion inhibitor, paraffin product, H₂S scavenger, or foamer. Additionally, the product 30 could be an emulsifier, non-emulsifier, wetting agent, sludge preventive, retarder, suspension agent, anti-swelling agent, or stimulation additive.

Enzymes may be packaged with the solid chemical well treatment product 30 as a part of the solid chemical silica matrix created at step 102. Enzymes used for these purposes may comprise lipases, proteases and amylases. Enzymes, when used together in the solid chemical treatment matrix with the well treatment product 30, promote more efficient delivery of well treatment product to the subterranean formation 14. Heating the well treatment product 30 through providing heated fracturing fluid 28 alone or in conjunction with an enzyme may improve the ability of the well treatment product to enter the fracture of the subterranean formation 14.

With reference to FIG. 3, a coating 31 may be provided on an outer surface of the solid chemical well treatment product 30, The coating 31 may comprise a polyvinylidene chloride (“PVDC”) resin such as SARAN™. Methods for coating solids with these particular coating substances may be found in U.S. Pat. No. 3,264,131, issued to Nagel, and U.S. Pat. No 5,373,901, issued to Norman, et al. In both references, a fluidized bed 200 is utilized to apply the coating to a product. A spray coating system 202 may also be utilized. In the present method, the well treatment product 30 is coated with a coating 31 prior to the step of providing the coated solid chemical 33 to the wellbore at 114 (FIG. 2).

The encapsulating material 32 making up the coating 31 may comprise a partially hydrolyzed acrylic, preferably in an aqueous based form which is cross-linked either with an aziridine prepolymer or a carbodiimide. The encapsulating material 31 is preferably admixed with a particulate micron-sized material such as silica dust of a size range from 1 micron to 15 microns. Preferably, the silica comprises from 0%-60% by weight of the coating 32 solids. The encapsulating material 31, when applied to the well treatment chemical 30, may bias to the shape of the coated well treatment chemical 33 to a spheroid or ellipsoid.

The coating 32 thickness may be adjusted to provide time-delay of the release of the well treatment product 30. As one skilled in the art will appreciate, liquid products have associated weaknesses, such as immediate delivery to a treatment location and an inability to control the delivery of chemical product over time. Similarly, time-release matrices such as that previously invented by the applicant may provide a set time-release, but in mineral production applications, time-release on the order of years is desired. The coatings chosen, thicknesses of the coatings, porosity of coatings, solubility of the coatings, and the percentage of well treatment chemical 30 coated by said coatings will meter the release of well treatment chemical. Alternatively, various coatings could be used having differing properties to similarly meter the release of well treatment chemicals. Water-based coatings may be preferred, but are not required to perform the steps of the disclosed invention.

One skilled in the art can envision other potential combinations of the principles disclosed in the above embodiments. For example, while an amorphous anhydrous silica delivery system for the well treatment product 30 is disclosed, other delivery systems such as ceramic, diatomaceous earth, lava rock, etc. may be utilized.

What is claimed is:

1. A device for delivering a well treatment chemical into a wellbore prepared by a process comprising:
heating an amorphous silica matrix to drive off moisture contained therein to form an anhydrous silica;
mixing the anhydrous silica with a well treatment chemical to absorb the well treatment chemical with the amorphous silica matrix to form a solid chemical; and
coating the solid chemical in a fluidized bed.

2. The device of claim 1 wherein the well treatment chemical comprises at least one of the following selected from: emulsifiers, corrosion inhibitors, scale inhibitors, non-emulsifiers, wetting agents, sludge preventives, retarders, suspension agents, anti-swelling agents, or stimulation additives.

3. The device of claim 1 wherein the anhydrous silica comprises a silica spheroid.

4. The device of claim 1 wherein the coating is polyvinylidene chloride.

5. The device of claim 1 wherein the coating is an acrylic resin.

6. A method for delivering a liquid chemical agent in a solid form, the method comprising:
heating an amorphous silica matrix to drive off moisture contained therein to form an anhydrous silica;
mixing the anhydrous silica with a well treatment chemical to absorb the well treatment chemical with the amorphous silica matrix to form a solid chemical;
coating the solid chemical; and
pumping the solid chemical, a proppant, and a fracturing fluid into the wellbore;
wherein the solid chemical is positioned within a fracture created by the fracturing fluid and provides a metered release of the well treatment chemical therefrom.

7. The method of claim 6 wherein the well treatment chemical comprises at least one of the following selected from: scale inhibitors, corrosion inhibitors, paraffin products, H₂S scavengers, or foamers.

8. The method of claim 6 further comprising providing a solar heat source, diverting the fracturing fluid into the solar heat source, heating the diverted fracturing fluid, and providing the heated fracturing fluid to the well bore upstream of the fracture.

9. The method of claim 6 wherein the solid chemical is coated with acrylic resin.

10. The method of claim 9 wherein the solid chemical is coated with silica particulate entrained within the acrylic resin.

11. The method of claim 9 wherein the acrylic resin is crosslinked with an aziridine prepolymer.

12. The method of claim 6 wherein the metered release of the well treatment chemical occurs over a period of at least one year.

13. The method of claim 6 wherein the solid chemical is an ellipsoid.

14. The method of claim 6 wherein the solid chemical is coated in a fluidized bed.

15. A well treatment product comprising:
an anhydrous, amorphous precipitated silica matrix comprising a plurality of interstitial spaces, wherein a well treatment chemical is located within the plurality of interstitial spaces; and
a degradable coating located about the silica matrix.

16. The well treatment product of claim 15 wherein the degradable coating comprises the solid chemical is coated with acrylic resin.

17. The well treatment product of claim 15 wherein the well treatment chemical comprises at least one of the following selected from: scale inhibitors, corrosion inhibitors, paraffin products, H₂S scavengers, or foamers.
